(19) United States
(12) Patent Application Publication
(10) Pub. No.: US 2009/0008371 A1
(43) Pub. Date: Jan. 8, 2009

(54) APPARATUS FOR THE CUTTING OF TECHNICAL FABRICS, IN PARTICULAR FOR AIRBAGS

(76) Inventors: Jurgen Held, Heusenstamm (DE); Siegfried Held, Bad Homburg (DE); Achim Zinke, Heusenstamm (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/167,721

(22) Filed: Jul. 3, 2008

(30) Foreign Application Priority Data
Jul. 4, 2007 (DE) 202007009631.3

(51) Int. Cl. B23K 26/00

(52) U.S. Cl. 219/121.67

(57) ABSTRACT

The invention relates to an apparatus for the cutting of technical fabrics, in particular for airbags, by means of laser radiation. Such fabrics in question are usually placed or folded over one another in multiple layers and then separating layers made of a foil or of paper are positioned between the individual layers and have to be removed again in a very complex and/or expensive manner after the cutting using laser radiation. It is therefore the object of the invention to provide possibilities for the cutting of fabric for airbags with increased flexibility, machining speed and reliability.

The apparatus in accordance with the invention has at least one deflectable laser beam which is directed to a fabric carrying out a feed movement along an axis. In this respect, at least one reflecting element pivotable around an axis is arranged on a portal above the single-layer fabric and can be moved by means of a drive at an angle to the feed axis direction of the fabric and a laser beam of a laser light source is directed to the reflecting element.

The invention relates to an apparatus for the cutting of technical fabrics, in particular for airbags, by means of laser radiation.

Such fabrics in question are usually placed or folded over one another in multiple layers and then separating layers made of a foil or of paper are positioned between the individual layers and have to be removed again in a very complex and/or expensive manner after the cutting using laser radiation.

In experiments to cut these fabrics in single layers, the restricted possible fabric width which can be machined using a laser beam which can also be deflected has a negative effect on the production costs.

This can admittedly be combated by the use of a plurality of laser beams which are directed onto the fabric to be cut by means of pivotable reflecting elements (scanner mirrors). If, however, a single one such stationary arranged reflecting element fails, this results in the failure of the system until a replacement or a repair has occurred.

The machining speed and flexibility of systems made in this manner is also limited.

It is therefore the object of the invention to provide possibilities for the cutting of fabric for airbags with increased flexibility, machining speed and reliability.

This object is solved in accordance with the invention by an apparatus having the features of claim 1.

Advantageous aspects and further developments of the invention can be achieved using features designated in the subordinate claims.

An apparatus in accordance with the invention is made such that the fabric carries out a feed movement along an axis. In this respect, at least one deflectable laser beam is directed to the fabric for the cutting of the fabric with preset marginal contours. The laser beam is deflected along the desired marginal contours by a reflecting element which is pivotable around at least one axis and which is arranged at a portal above the fabric and said laser beam is simultaneously moved by a drive at the portal at an angle to the feed axis direction of the fabric. In this respect, directions of movement and also different path lengths in both directions are possible.

A larger fabric width can thereby be taken into account with an increased machining speed. It is possible to work in remote technology.

The flexibility, machining speed and reliability of the apparatus in accordance with the invention can be further increased in that two or more than two such pivotable and movable reflecting elements are present and in that they can additionally be pivoted around two axes. A cutting can thereby take place simultaneously using a plurality of laser beams at different positions. The movement and deflection of the laser beams can be optimized in accordance with the marginal contours to be formed.

One or also more portals can be present at an apparatus having pivotable and movable reflecting elements.

One or more portals can also be moved in the feed axis direction of the fabric, with then the reflecting elements arranged thereon likewise being moved along in this direction so that an “overlaid feed movement” can likewise be achieved in this direction which can result in higher machining speeds.

The different movements and pivoting movements can be electronically controlled. For this purpose, the respective drives for the pivoting and movement of the reflecting elements and also for the movement of the one or more portals can be connected to a common electronic control and can be manipulated thereby in a program controlled manner.

An overlaying of a plurality of movements and also the deflection of the laser beams by pivoting of the reflecting elements are thus simultaneously possible.

On the failure of at least one drive, a reaction is possible by a corresponding program change and work can continue at least with a somewhat reduced machining speed.

It is favorable in this case or optionally even with very different marginal contours, which have to be made very different in part, also to vary the feed speed of the fabric at the fabric to be cut, which is likewise possible with the electronic control. In this connection, the fabric can moved faster or also more slowly.

The movement axis of the pivotable reflecting elements can be aligned at an angle of between 75° and 90° with respect to the feed movement axis of the fabric. In this connection, angles less than 90° can be favorable while taking account of the path traveled on the feed of the fabric.

The one or more portals can then be aligned accordingly with their carriers. Their guides should, however, take the feed axis direction of the fabric into account and their movement should take place parallel thereto.

Pivotable reflecting elements can advantageously be arranged at a portal at both sides, that is, at the side in the feed direction of the fabric and at the side disposed opposite it. However, an arrangement is also possible solely or additionally below or between a double carrier. A slot arranged in this way can also be present at a portal parallel to the axis of movement of a reflecting element and the laser beam deflected onto the fabric in a reflecting manner thereby can pass through said slot. With a plurality of pivotable and movable reflecting elements attached to a portal, such a slot can be present for each element.

A further reflecting element, which is preferably arranged in a static manner, is preferably present at a portal for every single pivotable and movable reflecting element and a laser beam emitted by a laser light source can be directed by it onto a pivotable and movable reflecting element. This is as a rule done by reflection at an angle of 90°.

A plurality of pivotable and movable reflecting elements should be moved parallel to one another on the cutting. In this respect, however, respective different paths can be covered. Every single one of these reflecting elements and/or portals should admittedly be able to be manipulated by an electronic control, but should nevertheless be able to be pivoted and moved independently of one another, with different speeds and accelerations being able to occur.

Laser light sources can be used whose radiation is absorbed particularly well by the fabric; the selection of suitable light sources can take place under this aspect.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding German application No. 202007009631.3, filed Jul. 4, 2007, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. An apparatus for the cutting of technical fabrics, in particular for airbags, having at least one deflectable laser beam which is directed to a fabric carrying out a feed movement along an axis,
characterized in that at least one reflecting element pivotable around an axis is arranged on a portal above the single-layer fabric and can be moved by means of a drive at an angle to the feed axis direction of the fabric and a laser beam of a laser light source is directed to the reflecting element.

2. An apparatus in accordance with claim 1, characterized in that at least one second pivotable reflecting element to which a laser beam of a laser light source is directed is movable on a second portal by means of a drive at an angle with respect to the feed axis direction of the fabric.

3. An apparatus in accordance with claim 1, characterized in that the portal(s) is/are movable in the feed axis direction of the fabric.

4. An apparatus in accordance with claim 1, characterized in that the reflecting element(s) is/are pivotable around two axes aligned perpendicular to one another.

5. An apparatus in accordance with claim 1, characterized in that drives are connected to an electronic control for the movement and pivoting of the reflecting element(s).

6. An apparatus in accordance with claim 4, characterized in that the drive(s) for the movement of the portal(s) is/are connected to the electronic control.

7. An apparatus in accordance with claim 1, characterized in that the speed of the feed movement of the fabric can be controlled.

8. An apparatus in accordance with claim 1, characterized in that the feed movement of the fabric takes place on a traveling grate or a conveyor belt grate.

9. An apparatus in accordance with claim 1, characterized in that the control of the feed movement of the fabric takes place using the electronic control.

10. An apparatus in accordance with claim 1, characterized in that the movement of the reflecting element(s) takes place at an angle in the range of 75° to 90° with respect to the feed axis direction of the fabric.

11. An apparatus in accordance with claim 1, characterized in that two reflecting elements are arranged at two sides of a portal with respect to the feed axis direction of the fabric.

12. An apparatus in accordance with claim 1, characterized in that a laser beam is directed to a reflecting element arranged at a portal in a static manner and is directed by said reflecting element onto a pivotable and movable reflecting element.

13. An apparatus in accordance with claim 1, characterized in that the movement axis directions of a plurality of pivotable reflecting elements are aligned parallel to one another.

14. An apparatus in accordance with claim 1, characterized in that a slot aligned parallel to the axis of the movement is present on a portal for a pivotable and movable reflecting element and a laser beam is directed onto the fabric by it for cutting.
